(19) United States
(12) Patent Application Publication
(10) Pub. No.: US 2008/0007020 A1
(43) Pub. Date: Jan. 10, 2008

(54) TRAY FOR USE ON A WALKER

(76) Inventor: David L. Holman, Pine Hollow, OR (US)

Correspondence Address: SUNG I. OH, PROFESSIONAL LAW CORPORATION, 710 QUAIL VALLEY LANE, WEST COVINA, CA, 91791, US

(21) Appl. No.: 11/481,811

(22) Filed: Jul. 6, 2006

(51) Int. Cl. B60R 7/00

(52) U.S. Cl. 280/87.051; 135/66; 224/407

(57) ABSTRACT

A tray is mounted on the arms of a walker and which includes cup holders, and a compartment that can be closed by a lid that can then serve as a work surface. The lid of the compartment also includes a mirror and a light is mounted on the lid adjacent to the mirror.

### TECHNICAL FIELD OF THE INVENTION

The present invention relates to a tray that is used with walkers, which are used by people with walking disability or who are otherwise infirm to assist them in movement.

### BACKGROUND OF THE INVENTION

Persons experiencing problems with their legs or hips often resort to the use of a walking a frame to provide them partial support as they move from one place to another and to lend stability to themselves as they move or stand. Essentially the structure which has now become known as a “walker” is a device which consists of four connected legs so arranged that the person using the device may stand inside the device between the four legs and utilize crossbars extending parallel to the intended path of movement and which connect a pair of legs on each side, as handles by which the walker may be used to support the person who is using the same and by which the walker may be moved ahead to provide support for advancing movement.

The lower ends of the legs are generally and preferably provided with friction cups or other devices which will ensure a secure engagement with the floor while the connecting bars at the top on each side may if necessary be provided with appropriate handle structures to ease the utilization of the walker.

Frequently the walker is made as a collapsible structure in which the two legs which are intended to extend in front of the user are connected by a crossbar. These two legs are then rotatably connected or supported by the crossbar or structure attached thereto. Each of the two front legs is then part of a frame which includes the rear leg on each side; each of these frames may be swung toward the front of the unit in order to provide a collapsed and easily stored structure as well and may also be swung outwardly to open the unit to full supporting position. Appropriate latches may also be provided to hold the unit in the extended or open position.

To utilize a walker, the person stands within the enclosure with left and right hand grasping the left and right hand grasp, respectively, of the frame at either side of the person. In this position, with the weight on the arms transferred through to the ground via the frame, stability is provided to enable a person to stand with some confidence. To move forward a person lifts the frame from the ground and places it slightly in front of himself. With his weight partially supported by the frame via the grasping of the hand holds, the person moves forward within the partial enclosure of the frame. Once positioned within the partial enclosure, the person repeats the process lifting the frame, advancing it and moving to within the enclosure again.

It is readily apparent that the use of a walker frame occupies a person's hands and arms and inhibits the use of a person's hands for carrying objects. Thus, although a person who has difficulty walking may be able to move about, for example, in the kitchen so as to prepare a meal for himself, he would be unable to transfer a plate of food, or the like, to a position where he could sit and enjoy the meal. Thus, a major problem which occurs in the use of the walker is that, since it is a two-handed device and the person using it is usually infirm because of injury or other disability of the legs or because of age the person using the walker cannot carry any other object and certainly cannot take care of himself or herself in for instance preparing meals and carrying the necessary plates, objects and other materials back and forth, which activities are entailed in preparation of meals or for that matter in the performance of other household chores. Thus, very frequently a person who requires such a walker and who otherwise would be able to manage very well even though living alone finds it necessary to enter or join some community group where his or her needs may he taken care of.

### SUMMARY OF THE INVENTION

The above-discussed disadvantages of the prior art are overcome by a tray that is mounted on the arms of a walker and which includes cup holders, and a compartment that can be closed by a lid that can then serve as a work surface. The lid of the compartment also includes a mirror and a light is mounted on the lid adjacent to the mirror.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a tray for use on a walker embodying the present invention.

FIG. 2 is a sectional view taken along line A-A of FIG. 1.

FIG. 3 is a top plan view of the tray shown in FIG. 1.

FIG. 4 is a side elevational view of the tray shown in FIG. 1.

### DETAILED DESCRIPTION OF THE INVENTION

Referring to the figures, it can be understood that the present invention is embodied in a tray 10 for use on a walker. Tray 10 comprises a body 12 which can be formed of plastic material or the like. Body 12 has a first surface 14 that is a top surface when the tray is in use and a second surface 16 that is a bottom surface when the tray is in use.

A first end edge 20 is a forward edge when the tray is in use. First end edge 20 is arcuate. A second end edge 22 is a rear edge when the tray is in use. The second end edge is also arcuate. A longitudinal axis 24 extends between first end edge 20 and second end edge 22.

A first side edge 26 connects forward edge 20 to rear edge 22 and a second side edge 28 also connects the forward edge to the rear edge. A transverse axis 30 extends between first side edge 26 and second side edge 28. A first elongate slot 40 is defined through the body, and is located adjacent to first side edge 26 and extends from adjacent to first end edge 20 to adjacent to second edge 22 and has a width dimension 42 that extends in the direction of transverse axis 30 of the body. A second elongate slot 44 is defined through the body and is located adjacent to second side edge 28. Second slot 44 extends from adjacent to first end edge 20 of the body to adjacent to second end edge 22 of the body and has a width dimension 46 extends in the direction of transverse axis 30 of the body.

First and second cup-holder blind-ended bores 50 and 52 are defined in the body and extend from first surface 14 of the body toward second surface 16 of the body. The cup-holder bores are spaced apart from each other in the direction of transverse axis 30 of the body. The cup holder bores can include securing elements located adjacent thereto, such as handle-accommodating bores, such as bore 50, to accommodate handles of cups, or securing straps, such as hook-and-loop strap 52′, so the cups held in the cup-holder bores will be securely held in place.

A third blind-ended bore 54 is defined in the body adjacent to first end edge 20 and extends in the direction of longitudinal axis 24 of the body toward second end edge 22. Third blind-ended bore 54 forms a storage compartment for the tray and can be used to store items, such as medicine or the like.

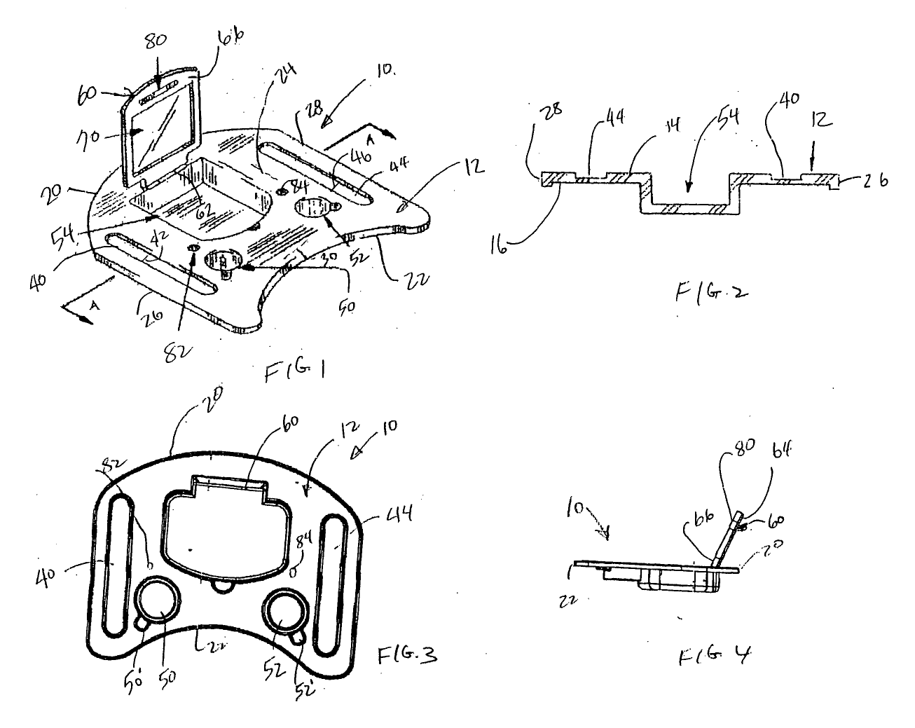

A lid 60 is hingeably mounted on first surface 14 of the body adjacent to third blind-ended bore 54 by a hinge element 62. Lid 60 is movable between a bore-covering position covering the third blind-ended bore and a bore-uncovering position, which is shown in FIGS. 1 and 4. The lid includes a first surface 64 that is an outside surface and is co-planar with first surface 14 of the body when the lid is in the bore-covering position and a second surface 66 which is an inside surface that is located inside the third blind-ended bore when the lid is in the bore-covering position.

A mirror 70 is mounted on inside surface 66 of the lid. A light-emitting element 80 is mounted on inside surface 66 of the lid adjacent to mirror 70. Two fourth blind-ended bores 82 and 84 are defined in first surface 14 of the body adjacent to third blind-ended bore 54. The fourth bores form pen light supporting bores for the tray.

Use of tray 10 can be understood from the teaching of the foregoing disclosure and thus will be only briefly discussed. Tray 10 is placed over the top rungs of a walker so those rungs are accommodated in slots 40 and 44 to securely mount the tray on the walker. Items can be stored in compartment 54, and accessed when lid 60 is moved into the open position such as shown in FIGS. 1 and 4. The mirror and light can also be used. The light can be designed to be activated when the lid is moved away toward the open position and to be de-activated when the lid is closed. Items, such as pen lights or the like can be stored in the bores 82 and 84 and cups can be held in bores 50 and 52. Other items can also be stored in the bores as will occur to those skilled in the art based on the teaching of this disclosure. Accordingly, the disclosure of cups and pen lights is intended to be examples only and is not intended to be limiting.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

1. A tray for use on a walker comprising:
A) a body having
(1) a first surface that is a top surface when the tray is in use,
(2) a second surface that is a bottom surface when the tray is in use,
(3) a first end edge which is a forward edge when the tray is in use, the first end edge being arcuate,
(4) a second end edge which is a rear edge when the tray is in use, the second end edge being arcuate,
(5) a longitudinal axis which extends between the first end edge and the second end edge,
(6) a first side edge which connects the forward edge to the rear edge,
(7) a second side edge which connects the forward edge to the rear edge, and
(8) a transverse axis which extends between the first side edge and the second side edge;
B) a first elongate slot defined through the body, the first slot being located adjacent to the first side edge and extending from adjacent to the first end edge of the body to adjacent to the second end edge of the body and having a width dimension that extends in the direction of the transverse axis of the body;
C) a second elongate slot defined through the body, the second slot being located adjacent to the second side edge and extending from adjacent to the first end edge of the body to adjacent to the second end edge of the body and having a width dimension that extends in the direction of the transverse axis of the body;
D) first and second blind-ended bores defined in the body and extending from the first surface of the body toward the second surface of the body, the bores being spaced apart from each other in the direction of the transverse axis of the body;
D) securing elements located adjacent to the first and second blind-ended bores;
E) a third blind-ended bore defined in the body adjacent to the first end edge and extending in the direction of the longitudinal axis of the body toward the second end edge;
F) a lid hingeably mounted on the first surface of the body adjacent to the third blind-ended bore, the lid being movable between a bore-covering position covering the third blind-ended bore and a bore-uncovering position, the lid including a first surface that is an outside surface and is co-planar with the first surface of the body when the lid is in the bore-covering position and a second surface which is an inside surface that is located inside the third blind-ended bore when the lid is in the bore-covering position;
G) a mirror mounted on the inside surface of the lid;
H) a light-emitting element mounted on the inside surface of the lid adjacent to the mirror; and
I) two fourth blind-ended bores defined in the first surface of the body adjacent to the third blind-ended bore.

2. (canceled)
